(19) United States
(12) Patent Application Publication
(10) Pub. No.: US 2010/0308592 A1
(43) Pub. Date: Dec. 9, 2010

(54) ENERGY CONVERTER WITH TRANSDUCERS FOR CONVERTING FLUID-INDUCED MOVEMENTS OR STRESS TO ELECTRICITY

(76) Inventor: Shawn M. Frayne, Tampa, FL (US)

Correspondence Address: SCHOX PLC, 500 3rd Street, Suite 515, San Francisco, CA, 94107, US

(21) Appl. No.: 12/740,349

(22) PCT Filed: Oct. 28, 2008
(86) PCT No.: PCT/US08/81425

§ 371 Date: Aug. 18, 2010

Related U.S. Application Data
(60) Provisional application No. 60/983,415, filed on Oct. 29, 2007.

(51) Int. Cl. F03B 13/00; H02N 2/18

(52) U.S. Cl. 290/54; 310/339

(57) ABSTRACT

An energy converter for inducing vibrations of a membrane when subject to a fluid flow, and converting the vibrations into another form of energy, such as electricity. The energy converter includes at least one flexible membrane supported and/or fixed at least two points and at least one transducer. The transducer is attached to the membrane or disposed in the proximity of the membrane. When subject to a fluid flow, the membrane vibrates and creates a stress on the transducer, which induces an electrical potential.

### PRIORITY

This application claims the benefit of U.S. Provisional Application No. 60/983,415, filed Oct. 29, 2007, and PCT/US2008/081425 filed Oct. 28, 2009 which application is incorporated herein by reference.

### CROSS-REFERENCE

This application relates to U.S. patent application Ser. No. 11/566,127, filed Dec. 1, 2006; and to U.S. Provisional Patent Application No. 60/950,227, filed Jul. 17, 2007; and to U.S. patent application Ser. No. 11/849,988, filed Sep. 4, 2007; and to U.S. patent application Ser. No. 11/849,997, filed Sep. 4, 2007; and to PCT Patent Application No. PCT/US2008/065307, filed May 30, 2008, and to PCT Patent Application No. PCT/US2008/065313, filed May 30, 2008, all the disclosures of which are incorporated herein in their entireties.

### FIELD OF DISCLOSURE

This application generally relates to techniques of harvesting energy from flowing fluids, such as air, water, etc., and more specifically, to unique designs and structures of energy converters that convert kinetic energies embedded in the flowing fluids to other types of energy, such as electricity, by promoting and utilizing oscillations induced by flowing fluids. In particular, this application focuses on such converters using a variety of transduction means that convert fluid induced movements to electricity.

### BACKGROUND AND SUMMARY

This disclosure describes various embodiments of novel energy converters, such as electrical generators, including at least one flexible member that effectively promote oscillations induced by flowing fluids, and utilize the oscillations in generating electricity or other types of energy by converting energy present in fluid flows, such as airflows, water flows, tides, etc. Each flexible membrane may have at least two fixed ends and vibrates when subject to a fluid flow. In some embodiments, each flexible membrane may have at least two ends supported by a supporting structure and may move when subject to a fluid flow. As used herein, the term “flexible membrane” refers to a flexible material capable of morphing into a large variety of determinate and indeterminate shapes in response to the action of an applied force. In one aspect, an exemplary generator harnesses the kinetic energy of fluid flows by way of aeroelastic flutter induced along a tensioned membrane fixed at two or more points. At least one transducer is provided to convert movements or stress, which is induced by the oscillations, to electricity. In one embodiment, the transducer converts an applied stress or a compression and/or stretch caused by the moving or oscillating membrane, to electricity. For instance, the transducer may be implemented with one or more piezoelectric elements, electroactive polymers (EAPs) or dielectric elastomers.

According to one embodiment, the at least one piezoelectric transducer may be attached to, and move with, the membrane. For instance, one or more piezoelectric elements are integrated into or onto either side or both sides of the oscillating membrane. In another embodiment, the at least one piezoelectric transducer may be disposed in the proximity of the membrane, and subject to stress caused by the moving membrane. In certain variations the piezoelectric element may function as both the stress-to-electricity transducer and as the flexible membrane. The piezoelectric element can form all or part of the flexible membrane. Moreover, in certain variations the piezoelectric element may be incorporated into a mounting or supporting structure which is compelled into a vibration by the oscillation of the membrane.

The flowing fluid induces a spontaneous instability in the membrane known as aeroelastic flutter, or simply “flutter”. The flutter of the membrane results in a high energy oscillation mode, with a reduced torsion oscillation near the piezoelectric elements nearer the ends of the membrane. Additionally, vortices shedding may occur along the edges and surface of the membrane, in some cases enhancing the oscillation.

The vibration of the membrane induced by the fluid flow causes a stressing of the one or more piezoelectric elements which is then translated into a flow of current at a particular voltage, as determined by the amplitude of vibration, the frequency of vibration, the load conditions, and the characteristics of the piezoelectric elements.

This electric generator operates at a variety of fluid flow speeds, including lower speeds than required for most turbine-based generators. Moreover, the cost of an exemplary generator of this disclosure is substantially lower than most other fluid-flow harvesting generators. The absence of physically grinding parts offers the possibility of long, quiet, maintenance-free operation. No leading bluff bodies are required to initiate or sustain oscillation, although they can be employed if desired.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1a is a perspective view of an exemplary generator according to this disclosure.

FIG. 1b is a side view of the exemplary generator shown in FIG. 1a.

FIGS. 2a-2b show close-up side views of an alternative arrangement of the exemplary generator described in FIGS. 1a-1b.

FIG. 3 is a perspective view depicting a plurality of stackable generator units.

FIG. 4 is a perspective view of another embodiment of an exemplary generator.

FIG. 5 is a perspective view of yet another embodiment of an exemplary generator.

FIG. 6 is a close-up side view of an embodiment of an exemplary generator incorporating transduction means into a mounting structure.

FIGS. 7a-7b are close-up perspective views of a variation of an exemplary generator incorporating a plurality of transducers in a stack-like arrangement.

FIG. 8 is a close-up perspective view of an embodiment of an exemplary generator wherein the transduction means also functions as the flexible membrane.

### DETAILED DESCRIPTION OF ILLUSTRATIVE EMBODIMENTS

In the following description, for the purposes of explanation, numerous specific details are set forth in order to provide a thorough understanding of the present disclosure. It will be apparent, however, to one skilled in the art that the present disclosure may be practiced without these specific details. In other instances, well known structures and devices are shown in block diagram form in order to avoid unnecessarily obscuring this disclosure.

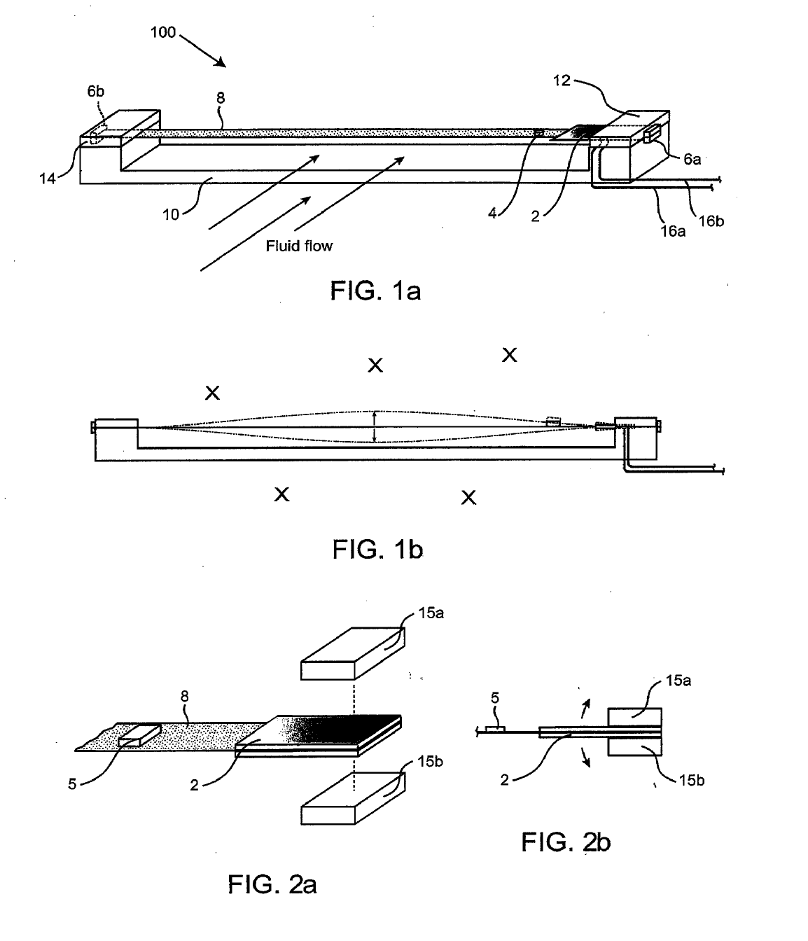

FIG. 1a depicts an exemplary generator 100 according to this disclosure. The generator 100 includes a supporting structure and an elongated membrane 8. The supporting structure comprises a supporting base 10 and two supporting structure clamps 12 and 14. As used herein, the term “supporting structure” is defined as any structure that has sufficient strength to support at least one affixed membrane. The supporting structure may be of any material, type, shape, and may be manmade or natural.

The membrane 8 may be made from a flexible material, such as ripstock nylon, super thin polyester film, mylar-coated taffeta, Kevlar tapes, fused silicon, rubber, plastic or steel strapping or banding, or polyethylene film, etc. The membrane 8 may have two main surfaces on opposite sides and two thin edges. In this disclosure, a surface plane of a membrane is defined as a plane on which one of the main or largest surfaces is disposed. The membrane 8 may have at least two ends supported by the supporting structure. In some embodiments, the at least two ends are fixed. In other embodiments, at least one end of the membrane may be fixed while the other supported end may be configured to move with the support structure, or at least two supported ends may be configured to move with the support structure. As provided for the disclosure herein, a supported end may or may not be fixed, and a fixed end may or may not be supported.

In some embodiments, one or more supported end may be (substantially stationary, e.g., fixed) or may be configured to move along a path restricted by the supporting structure. For example, one or more end of a membrane may be connected to a wheel, such that the wheel rotationally oscillates when the membrane oscillates, and the one or more end of the membrane may move along a curved path with the wheel. In another example, one or more end of a membrane may be connected to a supporting structure including a conduit, such that the one or more end of a membrane may move along a fixed lateral path within the conduit, or any other direction defined by the conduit. In yet another example, one or more end of a membrane may be connected to a cantilever, such that the cantilever may oscillate when the membrane oscillates, and the one or more end of the membrane may move along a path defined by the end of the cantilever. Further descriptions of supporting structures are provided below in accordance with various embodiments of the invention, but they are provided by way of example only and are not limiting.

One or more transducers 2, such as piezoelectric elements, may be affixed to one or more main surfaces of the membrane 8. More or less transducers 2 with varying physical properties may be employed to achieve desired cost and power efficiencies and resonance with the membrane's oscillation frequency. This transducer 2 can be partially clamped into the supporting structure 10 with structure clamp 12. One or more membrane masses 4 may also be affixed to one or more main surfaces of the membrane 8. The membrane mass 4, which may be made of any material, such as steel, plastic, wood, etc., often helps to encourage vigorous and self-starting oscillation of the membrane 8 and thereby enhances electrical output from the transducer 2. This membrane mass, when made of particularly light materials, can also disrupt airflow in such a way so as to also encourage vigorous oscillation by way of aerodynamic instability.

Tensioning devices, such as membrane anchors sets 6a, 6b, may be provided to maintain tension of the membrane 8 when the membrane 8 is attached to the supporting structure. As shown in FIG. 1a, the anchor sets 6a, 6b are attached near both ends of the membrane 8 at a specific separating distance, for applying a tensioning force to the membrane 8. It is understood that other devices known to people skilled in the art, such as screws, adhesives, clamps, wires, strings, hooks, staples, nails, etc., may be used to implant the tensioning device for applying a tensioning force to the membrane 8. For instance, the membrane 8 may be clamped between the supporting base 10 and supporting structure clamps 6a, 6b, to provide the needed tensioning force. The ends of the membrane 8 may be fixed at the supporting structure clamps 6a, 6b.

Leads 16a-16b may be coupled to the transducer 2. The tension force applied to the membrane 8 may be a function of the elasticity of the membrane and the physical characteristics of the supporting structure, along with the particular distance between the ends of the supporting structure relative to the distance between the anchor sets 6a and 6b.

The exemplary generator 100 shown in FIG. 1 may operate as follows. A flow of fluid may travel across the elongated and tensioned membrane 8. Examples of fluid flows may include flowing water or a flow of air like that found in artificial ventilation systems or in natural wind. The fluid flow may travel in a direction ranging from 0 to 180 degrees relative to the major axis of the membrane 8, with perpendicular flow (e.g. 90 degree to the major membrane axis along the surface planes of the membrane 8) giving approximately the most energetic oscillation. Fluid may flow from either side of the generator 100. One example of this fluid flow is indicated by three arrows in FIG. 1. The fluid flow may initiate a self-exciting instability (e.g., flutter) in the membrane 8 which is enhanced through a positive feedback loop of competing fluid deflection and membrane tension forces, until an approximately constant oscillation state is achieved. The majority of the membrane 8, such as the middle section, undergoes a combination of moderate torsional (e.g., slight back-and-forth rotation along the major axis of the membrane 8) and “rising and falling” travel (the profile of the “rising and falling” travel of the membrane 8 is depicted in FIG. 1b), which is recognizable as a “flutter” oscillation. The generator 100 translates the torsional and “rising and falling” movements of the membrane 8 into a reduced torsion oscillation at the location of the transducer 2 on the membrane 8. Also, a more highly torsional oscillation of the transducer 2 is achievable utilizing the same construction of generator 100, requiring only a slight alteration to the tensioning of the membrane 8 and placement of the membrane mass 4. However, in many instances this highly torsional oscillation produces less electrical output than then reduced torsion oscillation. In some embodiments, the oscillation of a membrane may reach a state such that the membrane may move with at least one mode of vibration with two or more nodes.

FIGS. 2a and 2b depict an oscillation where the transducer 2, the membrane mass 5, and the end of the membrane 8 with the transducer 2 attached move in a reduced torsion, slightly arched path, with small arrows indicating the movement of the transducer 2. This reduced torsion oscillation of the transducer 2 may create a stress on the transducer 2. In those cases where the transducer is implemented with one or more piezoelectric elements, such as PVDF (e.g., Polyvinylidene Fluoride) film, bimorph ceramic piezoelectric materials, or piezoelectric fibers or any number of other piezoelectric materials well known in the art, this bending stress is directly converted into an electromotive force (EMF).

In the embodiments in which the transducer is implemented with electroactive polymers (EAP) or dielectric elastomers (DE), electrical energy may be generated as a result of a change in capacitance of the transducer when it is stretched and compressed. When the transducer oscillates with the membrane or is subject to stress caused by the movement of the membrane, or in those cases where the transducer also functions as the oscillating membrane, the transducer may be compelled into cycles of compression and stretching. During the part of this oscillation cycle in which the transducer is in a stretched state, electrical energy in the form of electrical charge may be placed on the transducer's surfaces, thereby establishing a certain capacitance for this stretched state of the transducer. When the transducer is then compelled into the compression or contraction part of the oscillation cycle, the capacitance for the transducer changes such that electrical energy may be drawn from transducer before the next “stretch” part of the cycle begins. This means of electrical transduction is largely governed by well-known physics in which a change in capacitance can generate an EMF capable of performing work.

The EMF in both the piezoelectric and the electroactive polymer and dielectric elastomer cases may create an alternating current, i.e., a flow of electrons, dependent on the load conditions, internal resistance, impedance, and a range of other factors. The generator 100 has significant advantages over conventional generators in that no sliding contacts, gears, axles or physically grinding parts are required to generate an electrical flow.

The membrane mass as described in this disclosure may assume many different sizes, shapes and configurations, and can be disposed at different locations relative to the membrane. As shown in FIGS. 2a-2b, the membrane mass 5 may be of a rectangular shape, whereas the mass 4 in FIG. 1a may be a cylindrical shape. This slight variation has been included to highlight the wide array of functional options related to the particular geometry, mass, and placement of this membrane mass component. In certain cases, the mass 4 or 5 will be centered on the centerline of the long axis of membrane 8. In other embodiments, the mass 4 or 5 may be offset from the centerline of the long axis of membrane 8, to induce the flutter oscillation more readily when fluid flows from a particular direction across the membrane 8.

The configuration shown in FIG. 1a, and further clarified in FIG. 1b, is designed in a specific manner to stress the transducer 2, such as piezoelectric element, with large displacement and bending force for a given fluid flow over the membrane 8. The stress applied to the transducer 2 may be increased by well-known lamination techniques, whereby a bending force on a discrete portion of the transducer is greatly enhanced along a greater area of the transducer element.

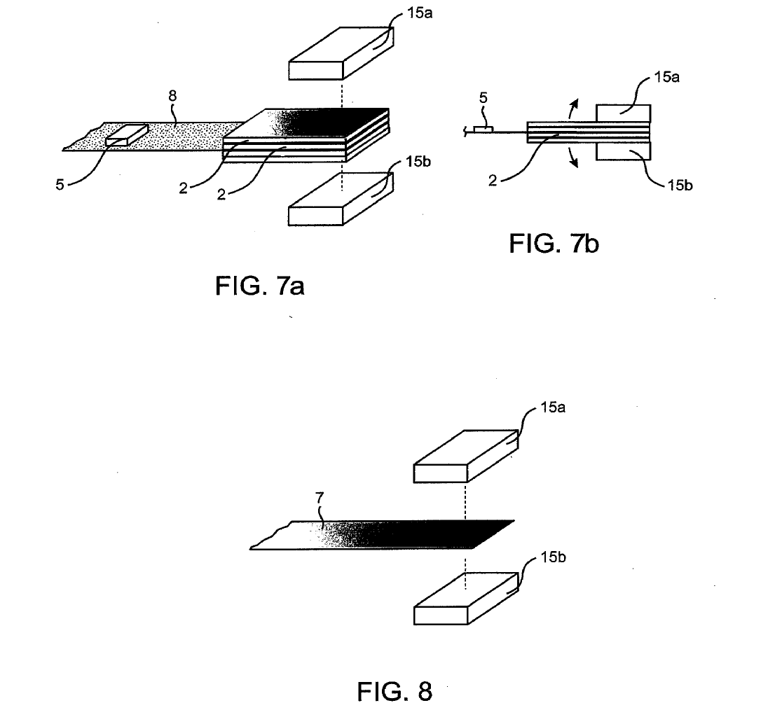

Also, as depicted in FIGS. 7a-7b, multiple transducer elements 2 may be stacked. These elements may be adhered to one another, or laminated together; this too is a well-known technique in the art of piezoelectric transducers. A membrane 8 may be connected or may be included as part of the stack. The membrane 8 may or may not have a mass 5 affixed to it. The stack may or may not be supported by a supporting structure such as clamps 15a, 15b.

As shown in FIG. 1a, the membrane 8 may be disposed between the clamps 12, 14 and the supporting base 10. The clamps 12 and 14 may be fixed to the supporting base 10 by any affixing means, such as by adhesive or mechanical fasteners like bolts with nuts or screws, as well as via many other well-understood options. The membrane mass 4 may be affixed to the membrane 8 using various types of affixation means, such as adhesive or bolt or screw-like fasteners. The anchor sets 6a, 6b may be affixed to the membrane 8 through any kind of affixing means as well. In one embodiment, the anchor sets 6a, 6b may be adhered to the membrane 8 with adhesive. These anchor sets 6a, 6b may be separated by a pre-defined distance. This pre-defined distance relative to the overall length of the supporting base 10 can establish a particular tension of the membrane 8.

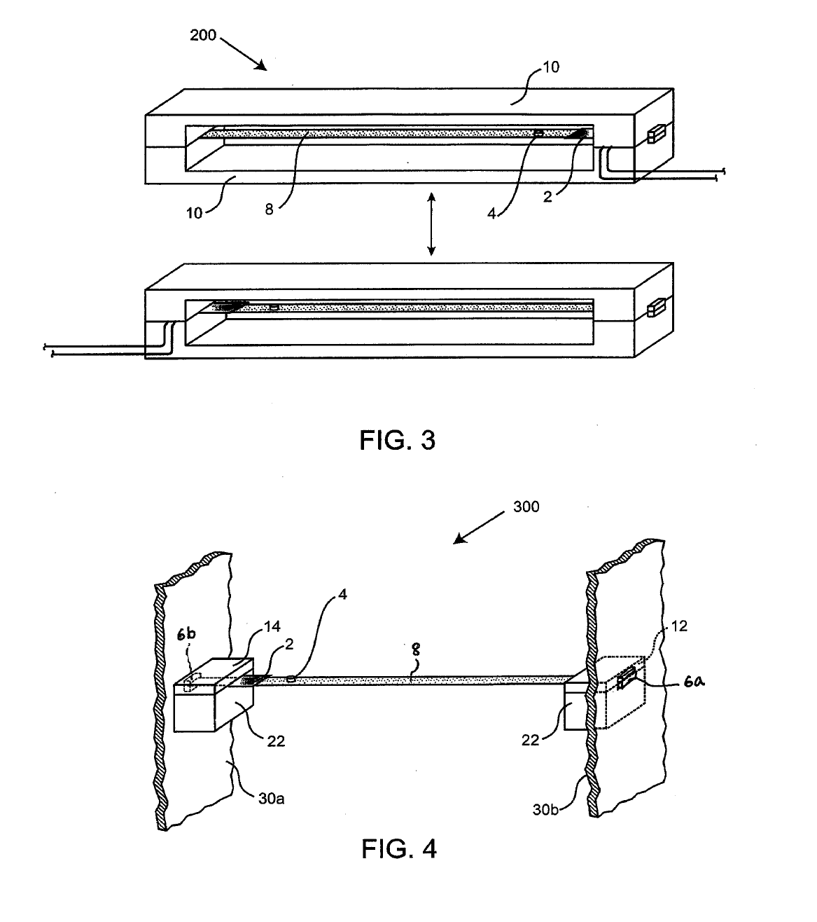

FIG. 3 depicts a perspective illustration of two exemplary generators 200. If the membranes 8 of the two generators are oscillating in phase, the alternating electrical output of the two generators may be directly combined in either series or parallel and then conditioned. In some cases it may be advantageous to first condition the alternating output of each independent generator into a direct current and then combine the two DC outputs from the two generators, so as to avoid destructive interference. Unlike the generator 100 shown in FIG. 1a which uses separate clamping means to connect the membrane 8 to the supporting structure, the generator 200 may utilize two approximately identical supporting structures 10 affixed to one another, thereby capturing the membrane 8 and the transducer 2 between the anchor sets 6a, 6b. The supporting structures 10 are attached to one another through an adhesive. It is understood that other types of fastening devices, such as mechanical fasteners, can be employed. This construction may provide multiple advantages: ease of manufacture (e.g., fewer different components to manufacture), straightforward generator “stacking”, and in some cases the concentrated and directional channeling of fluid flow through a wide conduit, yielding enhanced oscillation.

FIG. 4 is a perspective view of another exemplary generator unit 300. The supporting structure of the generator 300 does not need to extend along the length of the membrane 8 if suitable separated fixture points can be created or identified. In this particular embodiment, clamps 14 and 22 trap one side of the membrane 8, and clamps 12 and 22 trap the other side of the membrane 8. These clamps may be attached to vertical surfaces 30a, 30b. As with the previous embodiments, the tensioning of the membrane 8 is established when the anchor sets 6a, 6b attached to the membrane 8 are stretched to, and fixed at, a given distance from one another. In this case, the distance is defined by the distance between the surfaces 30a, 30b. Note that while the technique of pre-affixing anchor sets to the membrane allows for consistent tensioning of the membrane, a roughly consistent tensioning can also be achieved without use of the anchor sets. The clamps 12, 14 and 22 can simply trap the membrane under positive or minimal tension, either by pre-clamping the membrane and then adhering the clamps to the respective vertical surfaces 30a, 30b or capturing a given externally applied tensioning of the membrane while the clamps are affixed to the vertical surfaces 30a, 30b.

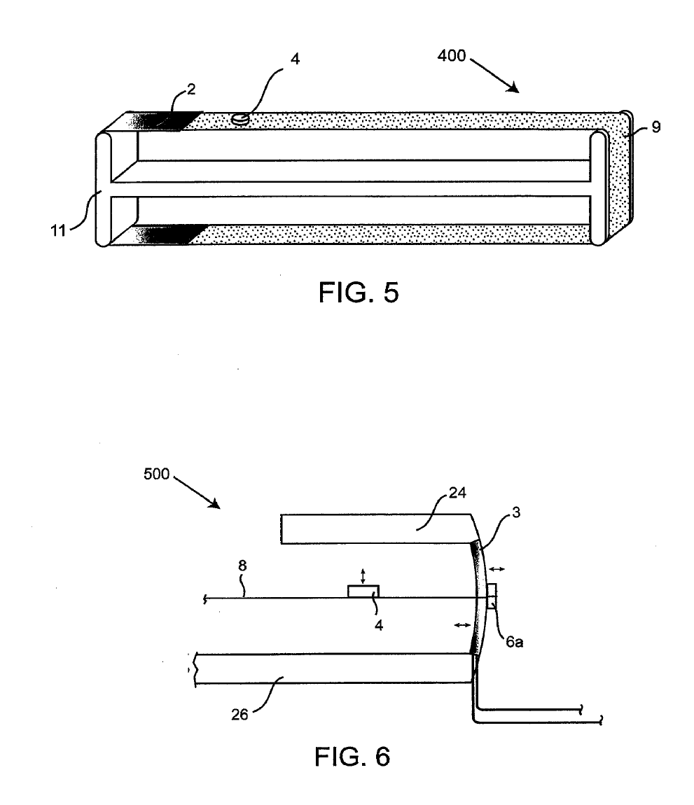

FIG. 5 depicts a variation of the generator shown in FIG. 1a. In this embodiment, indicated by the numeral 400, the membrane material is formed into a continuous loop or belt 9 encircling or wrapping around a supporting structure 11. The membrane loop may be formed by an elongated membrane having one end of the membrane attached to the other using various types of attachment means, such as adhesives, clasps, heat welding, adjustable ties, etc. The looped membrane 9 is then wrapped or fastened around the supporting structure 11. The loop length of the membrane and the dimensions of the supporting structure are carefully selected so that when the membrane loop 9 is formed and attached to the supporting structure 11, a sufficient membrane tensioning is created. Note that in this embodiment, the transducer element 2 is not clamped, but rather is looped around the edge of the supporting structure 11. While a clamp can be added to enhance electrical output in certain cases, this loop-around variation offers enhanced lifetime of the transducer 2 and membrane 8.

In this particular embodiment, membrane anchors as described relative to FIG. 1a may not be required. The fixed circumference (e.g., loop length) of the looped membrane may provide the consistent membrane tensioning on a fixed mounting structure that the anchors sets provide in other embodiments. An additional advantage of this embodiment is that equal tensioning may be applied on two opposing sides of the mounting structure. Because the forces on two opposing sides of the mounting structure may be substantially equivalent, and compressive in nature, the requirement for rigidity of the mounting structure can be reduced. Additional cost benefits may also be gained with multiple active membranes sharing a common mounting structure (e.g., a membrane “loop” may serve as two active oscillating membranes, although this dual-use is not necessary). In addition, as the membrane loop is not clasped into a mounting structure or clamp, but rather wraps around the mounting structure, the wrapping, rather than clamping, may mitigate the stress on the membrane at the interface with the mounting structure, and as aforementioned, thereby offers increased lifetime of the membrane and transducer.

FIG. 6 depicts a variation in which a transducer element 3 is implemented with one or more piezoelectric elements, is affixed to or incorporated into the supporting structure. Instead of stressing a transducer affixed to a membrane 8, the vibration of the membrane 8 may cause a vibration of the supporting structure, comprised of cantilevered element 24 and elongated element 26. This vibration may also cause additional vibration, and stress, to the transducer element 3, thereby leading to generation of an alternating electrical output by the transducer elements. This embodiment may be useful when stiff piezoelectric elements, such as ceramic bimorphs, or constrained electroactive polymers or dielectric elastomers are employed.

In some embodiments, the transducer element 3 may form a portion of the supporting structure adjacent to the end of the membrane 8. In some embodiments, the transducer element 3 may be in contact with the membrane 8. A transducer element may be disposed in the proximity of the membrane wherein the flutter of the membrane directly creates a stress on the transducer. In some implementations, the flutter of the membrane may directly create stress on the transducer without going through intermediate structures (e.g., going through an intermediate structure could include the movement of the membrane causing a component to move, and the component causes a stress on a transducer).

FIG. 8 is a perspective view of another variation of an exemplary generator. In this particular instance, the transducer element 7 may be a film which can also serve as the flexible membrane that undergoes an aeroelastic flutter oscillation. In one implementation, an end of the transducer element 7 may be supported by one or more clamps 15a, 15b. In some instances, the transducer element may form all or a part of the membrane that undergoes aeroelastic flutter oscillation. For example, one or more portions of the membrane may comprise a film that is a transducer element. The one or more portions of the membrane that may comprise the film may have any shape or may form may form any portion of the membrane. For example, it may be desirable to have transducer films at certain points along the length of the membrane. In another example, it may be desirable to have a transducer film run along the length of the membrane, but to include other elements along the length of the membrane as well. In another example, the entire membrane is formed of a film that is a transducer element.

When the transducer element is a piezoelectric film, such as PVDF, or a dielectric elastomer or electroactive polymer, this embodiment can yield cost and complexity savings over the other embodiments. A membrane mass may or may not be included in this embodiment. While the membrane mass may be useful in creating substantially energetic oscillations, or oscillations with controllable noise output, it is not necessary in all situations, particularly when the generator is very small.

Some variations of the embodiments described herein include transducer elements disposed on both ends of the membrane 8, or disposed in the center region of membrane 8. Also, the transducer element does not necessarily need to be clamped by physical clamping means, but rather may undergo less dramatic flexing while unclamped.

Also, this new class of generator, which converts fluid flows into electrical output, works on a variety of scales, from the sub-milliwatt to the watt range. An interesting application is the use of small generators of this sort for powering wireless sensor nodes, either continuously or intermittently, by recharging a capacitor or battery. In this case, it may be advantageous to quickly apply the generator and sensor to a particular surface, say to the interior wall of the ducting of a building. In this case, an adhesive or other fastening means may be applied along the underside of the generator's supporting structure, yielding a novel “peel-and-stick” fluid flow energy converter.

Also, while this application has focused on piezoelectric, electroactive polymer, and/or dielectric elastomer transducers, other types of transducers, such as electromagnetic (e.g., EMF induced by a changing magnetic field through a conductive coil) transducers may additionally be employed. For instance, the membrane mass 4 may be implemented using a magnetic material, such as an NdFeB magnet, and a stationary coil may be mounted in proximity to the magnetic mass and thereby additional electrical output can be created when the mass undergoes an oscillation. Detailed techniques and descriptions related to the use of magnetic elements and coils to generate electricity from the movements of the membrane are provided in U.S. patent application Ser. No. 11/566,127, filed Dec. 1; 2006, U.S. Provisional Patent Application No. 60/950,227, filed Jul. 17, 2007; U.S. patent application Ser. No. 11/849,988, filed Sep. 4, 2007; U.S. patent application Ser. No. 11/849,997, filed Sep. 4, 2007; PCT Patent Application No. PCT/US2008/065307, filed May 30, 2008; and PCT Patent Application No. PCT/US2008/065313, filed May 30, 2008, all of which are previously incorporated by reference.

Also, the transducer 2 may desirably also come into rapid contact, by way of impulse or impact, a stationary object, and thereby generate additional power output in certain cases. For instance, when the transducer 2 is made of a piezoelectric material, such as PVDF film, the oscillating transducer may desirably come into intermittent contact with a ball bearing or other stationary outcropping fixed on the supporting structure. When the transducer 2 rapidly and cyclically contacts this stationary member, a spike in voltage will often be produced in the transducer 2. This additional energy output is useful in some circumstances, particularly when non-laminated, non-constrained piezoelectric transducers are employed. However, it is recognized that this intermittent impact could reduce the lifetime of the generator.

Various types of supporting structures or mounting means may be used to implement the generators according to this disclosure. For example, instead of utilizing a rigid, stationary structure to hold the membrane under tension, a mobile, aerial floating or lifting device, such as a kite or balloon, can hold a membrane under tension. In this embodiment, the buoyancy and wind acting against the balloon, kite, or other aerial floating or lifting structure provide a tensioning on the membrane 8, one end of which may be attached to the ground or to be held taut between cables or straps attached to the ground and the aerial structure. According to one embodiment, a generator according to this disclosure, such as that shown in FIG. 1a, is attached to an aerial floating or lifting device like a balloon or kite, to allow the generator access to the higher wind speeds at great altitudes without the expense of a tall mounting tower.

It should also be noted that the membrane and the mounting structure should not be treated as completely independent from one another. Indeed, the oscillation of the membrane of these various embodiments also excites frequencies of oscillation in the mounting structure that houses the oscillating membrane. In a manner similar to the sustained and powerful vibrations of a fine stringed musical instrument, such as a violin or a guitar, the oscillation of the membrane may be enhanced by choosing appropriate materials and geometries of the mounting structure. Also, the oscillation of the membrane may be enhanced or dampened by isolating or securely joining the mounting structure to a grounded base, depending on the natural resonance of that grounded base. Resonating cavities molded into the mounting structure itself may enhance the vibration of the membrane as well.

Generators implemented according to this disclosure may be used to power flying vehicles, such as ultra-light, human-carrying planes or autonomous flying devices. The drafts and airflows present at higher altitudes can be captured by a plane-mounted generator of the sort disclosed herein, charging up a battery or capacitor bank to energize a propeller system.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. An electrical generator comprising:
a supporting structure;
a flexible membrane having at least two ends supported by the supporting structure, wherein the membrane moves when subject to a fluid flow; and
at least one transducer element attached to, or that forms all or a part of, the membrane, wherein the movement of the membrane caused by the fluid flow creates a stress on the transducer;
whereby the stress on the transducer creates an electrical potential and, when connected to an appropriate load, an electrical current.

2. The generator of claim 1 wherein the membrane has a substantially elongated shape between the two ends, and includes two main surfaces on opposite sides of the membrane and a first edge and a second edge.

3. The generator of claim 1 wherein the membrane includes a membrane loop supported by the supporting structure.

4. The generator of claim 1 wherein a mass is affixed to the membrane

5. The generator of claim 1 wherein the at least one transducer element includes at least one of PVDF film, bimorph ceramic piezoelectric materials, piezoelectric fibers, electroactive polymers, dielectric elastomers (DE).

6. The generator of claim 5 wherein the at least one transducer element further includes an electromagnetic transducer.

7. The generator of claim 1 wherein the at least one transducer element is a plurality of transducer elements.

8. The generator of claim 1 wherein the at least two ends supported by the supporting structure have at least one of the following characteristics: at least two ends are fixed, at least one end is fixed and at least one end is configured to move with the supporting structure, or at least two ends are configured to move with the supporting structure.

9. The generator of claim 1 further comprising:
at least one additional flexible membrane having at least two ends supported by the supporting structure, wherein the membrane moves when subject to a fluid flow; and
at least one transducer element attached to, or that forms all or a part of, the at least one additional membrane, wherein the movement of the membrane caused by the fluid flow creates a stress on the transducer.

10. An electrical generator comprising:
a supporting structure;
a flexible membrane having at least two ends supported by the supporting structure, wherein the membrane vibrates when subject to a fluid flow; and
at least one transducer element is in direct communication with the membrane, wherein the vibration of the membrane caused by the fluid flow creates a stress on the transducer;
whereby the stress on the transducer creates an electrical potential and, when connected to an appropriate load, an electrical current.

11. The generator of claim 10 wherein the transducer element is integrally connected with the support structure.

12. The generator of claim 10 wherein the transducer element forms a portion of the supporting structure adjacent to the end of the membrane.

13. The generator of claim 10 further comprising a tensioning device to provide tension to the membrane.

14. The generator of claim 10 wherein the at least two ends supported by the supporting structure have at least one of the following characteristics: at least two ends are fixed, at least one end is fixed and at least one end is configured to move with the supporting structure, or at least two ends are configured to move with the supporting structure.

15. An electrical generator comprising:
a flexible membrane having at least two fixed ends, wherein the membrane vibrates when subject to a fluid flow; and
at least one transducer element attached to, or that forms all or a part of, the membrane, wherein the vibration of the membrane caused by the fluid flow creates a stress on the transducer;
whereby the stress on the transducer creates an electrical potential and, when connected to an appropriate load, an electrical current.

16. The generator of claim 15 wherein a mass is affixed to the membrane

17. The generator of claim 15 wherein the at least one transducer element includes at least one of: PVDF film, bimorph ceramic piezoelectric materials, piezoelectric fibers, electroactive polymers, or dielectric elastomers.

18. The generator of claim 17 wherein the at least one transducer element further includes an electromagnetic transducer.

19. The generator of claim 15 wherein the at least one transducer element is configured to come into contact with a stationary object.

20. The generator of claim 15 wherein the at least one transducer element is laminated with at least one additional transducer element.

21. An electrical generating system comprising:
a supporting structure; and
multiple electrical generators of claim 15, wherein the multiple electrical generators are supported by the supporting structure.

22. The generator of claim 15 wherein the at least one transducer element is a film.

23. An electrical generator comprising:
a flexible membrane having at least two fixed ends, wherein the membrane flutters when subject to a fluid flow; and
at least one transducer element disposed in the proximity of the membrane, wherein the flutter of the membrane caused by the fluid flow directly creates a stress on the transducer;
whereby the stress on the transducer creates an electrical potential and, when connected to an appropriate load, an electrical current.

24. The generator of claim 23 wherein the at least one transducer element is in contact with the membrane.

25. The generator of claim 23 wherein the at least one transducer element is incorporated into a structure adjacent to the end of the membrane.

26. An electrical generator comprising:
a flexible membrane having at least one fixed end and at least one supported end, wherein the membrane vibrates when subject to a fluid flow; and
at least one transducer element attached to, or in direct communication with, or that forms all or a part of, the membrane, wherein the vibration of the membrane caused by the fluid flow creates a stress on the transducer;
whereby the stress on the transducer creates an electrical potential and, when connected to an appropriate load, an electrical current.

27. A method of generating electricity comprising:
subjecting a membrane with at least two fixed and/or supported ends to fluid flow; and
providing at least one transducer element attached to, or that forms all or a part of, the membrane, wherein
the movement of the membrane caused by the fluid flow creates a stress on the transducer, and
whereby the stress on the transducer generates a voltage.

28. The method of claim 27 wherein a mass is affixed to the membrane.

29. The method of claim 27 wherein the membrane moves with at least one mode of vibration with two or more nodes.
